(19) United States
(12) Patent Application Publication
(10) Pub. No.: US 2018/0090802 A1
(43) Pub. Date: Mar. 29, 2018

(54) CATHODE AND LITHIUM AIR BATTERY INCLUDING THE SAME, AND METHOD OF PREPARING THE CATHODE

(71) Applicants: Samsung Electronics Co., Ltd., Suwon-si (KR); Seoul National University R&DB Foundation, Seoul (KR)

(72) Inventors: Hyukjae Kwon, Suwon-si (KR); Kisuk Kang, Gwacheon-si (KR); Youngjoon Bae, Seoul (KR); Hyunjin Kim, Seoul (KR); Dongmin Im, Seoul (KR)

(21) Appl. No.: 15/715,645

(22) Filed: Sep. 26, 2017

(30) Foreign Application Priority Data
Sep. 27, 2016 (KR) 10-2016-0124245
Aug. 10, 2017 (KR) 10-2017-0101711

(51) Int. Cl. H01M 12/06; H01M 4/133; H01M 4/62

(52) U.S. Cl. CPC H01M 12/06; H01M 2004/028; H01M 4/624; H01M 4/133

(57) ABSTRACT

An air battery cathode includes a carbon composite including a core and a conductive coating layer disposed on the core, wherein the core includes a first carbon material and a second carbon material, wherein the conductive coating layer includes a metal-containing semiconductor.

### CROSS-REFERENCE TO RELATED APPLICATION

This application claims priority to and the benefit of Korean Patent Application No. 10-2016-0124245, filed on Sep. 27, 2016, and Korean Patent Application No. 10-2017-0101711, filed on Aug. 10, 2017, and all the benefits accruing therefrom under 35 U.S.C. § 119, the contents of which are incorporated herein by reference in their entirety.

### BACKGROUND

### 1. Field

The present disclosure relates to a cathode, a lithium air battery including the cathode, and a method of preparing the cathode.

### 2. Description of the Related Art

A metal-air battery, which is a type of electrochemical battery, includes an anode that allows deposition and dissolution of metal ions, a cathode where oxidation and reduction of oxygen from the air occurs, and a metal ion conductive medium disposed between the cathode and the anode.

In a metal-air battery, a metal is used as an anode, and oxygen, which does not need to be stored, acts as a cathode active material, and thus a metal-air battery may have high capacity. A metal-air battery also has a high theoretical specific energy of 3,500 watt hours per kilogram (Wh/kg) or greater.

A cathode, also referred to as an air electrode, may include a porous material. The porous material may include carbon having a large specific surface area and a porous structure. Lifespan characteristics of a metal-air battery may be decreased if an electrolyte is decomposed by oxygen and oxides, or if the carbon is deteriorated during charging and/or discharging of a metal-air battery.

A metal-air battery having improved lifespan characteristics, e.g., by suppressing the deterioration of the carbon of the cathode, or decomposition of the electrolyte, is desired.

### SUMMARY

Provided is a cathode having an improved structure.

Provided is a lithium air battery including the cathode.

Provided also is a method of preparing a cathode.

According to an aspect of an embodiment, an air battery cathode includes: a carbon composite including a core and a conductive coating layer disposed on the core, wherein the core includes a first carbon material and a second carbon material, wherein the conductive coating layer includes a metal-containing semiconductor.

According to an aspect of another embodiment, a lithium air battery includes a cathode; and anode; and an electrolyte layer disposed between the cathode and the anode, wherein the cathode includes:
a carbon composite including a core and a conductive coating layer disposed on the core,
wherein the core includes a first carbon material, a second carbon material, or a combination thereof,
wherein the conductive coating layer includes a metal-containing semiconductor.

According to an aspect of another embodiment, a method of preparing a cathode includes:
providing a first carbon material; and
preparing a carbon composite by depositing a coating layer on the first carbon material, the coating layer including a metal-containing semiconductor, to prepare the cathode.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a transmission electron microscopic (TEM) image showing carbon nanotubes (CNTs) of Comparative Example 1;

FIGS. 2A and 2B are each a TEM image showing carbon composite prepared according to Example 2;

FIG. 3A is a graph of intensity (arbitrary units, a.u.) versus Raman shift (per centimeter, cm⁻¹), which shows a Raman spectrum of carbon composite prepared according to Examples 1 and 2 and Comparative Example 1, and FIG. 3B is an enlarged view of the left side of the graph of FIG. 3A;

FIG. 4 is a graph of voltage (volts, V) versus capacity (milliampere hours per gram, mAh/g), showing charging/discharging of a lithium air battery prepared according to Example 9;

FIG. 5 is a graph of voltage (V) versus capacity (mAh/g), showing charging/discharging of a lithium air battery prepared according to Example 14;

FIG. 6 is a graph of voltage (V) versus capacity (mAh/g), showing charging/discharging of a lithium air battery prepared according to Example 15;

FIG. 7 is a graph of voltage (V) versus capacity (mAh/g), showing charging/discharging of a lithium air battery prepared according to Comparative Example 4;

FIG. 8 a graph of voltage (V) versus capacity (mAh/g), showing charging/discharging of a lithium air battery prepared according to Comparative Example 6;

FIG. 9 is a graph of voltage (V) versus capacity (mAh), showing charging/discharging of a lithium air battery prepared according to Example 12;

FIG. 10 is a graph of voltage (V) versus capacity (mAh), showing charging/discharging of a lithium air battery prepared according to Example 13;

FIG. 11 is a graph of voltage (V) versus capacity (mAh), showing charging/discharging of a lithium air battery prepared according to Comparative Example 5;

FIG. 12 is a graph of voltage (V) versus capacity (mAh), showing charging/discharging of a lithium air battery prepared according to Example 16;

FIG. 13 is a graph of gas evolution (micromole, pmol) versus cycle number, showing carbon dioxide emission of a lithium air battery prepared according to Example 12 with respect to charging/discharging of the battery;

FIG. 14 is a graph of gas evolution (pmol) versus cycle number showing carbon dioxide emission of a lithium air battery prepared according to Comparative Example 5 with respect to charging/discharging of the battery; and

FIG. 15 is a schematic diagram illustrating a lithium air battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, according to example embodiments, a cathode, a lithium air battery including the cathode, and a method of preparing the cathode will be described in detail.

As used herein, the term “metal” refers to metallic or metalloid elements as defined in the Periodic Table of Elements selected from Groups 1 to 17, including the lanthanide elements and the actinide elements.

“Metalloid” means B, Si, Ge, As, Sb, Te, or a combination thereof.

As used herein, “composite” refers to a material formed by combining two or more materials having different physical and/or chemical properties, wherein the composite has properties different from each material constituting the composite, and wherein particles or wires of each material are at least microscopically separated and distinguishable from each other in a finished structure of the composite.

The terms “non-insulating coating layer” or “conductive coating layer” as used herein refer to a coating layer which does not include an insulating material. For example, a non-insulating coating layer may be a conductive coating layer including a conductive material, a semi-conductive material, or a combination thereof.

A cathode according to an example embodiment may include a carbon composite including a core and a conductive coating layer disposed on the core. In the cathode, the core includes a first carbon material, a second carbon material, the second carbon material including a product of heat treatment of the first carbon material, or a combination thereof, and the conductive coating layer includes a metal-containing semiconductor, and a cathode active material is oxygen. When the conductive coating layer (e.g., non-insulating coating layer) including the metal-containing semiconductor is disposed on the core including the first carbon material, a defect present in the first carbon material may be healed, and accordingly, durability of the first carbon material may improve. In this regard, the lifespan characteristics of a lithium air battery including the cathode may improve.

During charging/discharging of the lithium air battery, an electrochemical reaction occurs on a surface of the first carbon material due to contact between lithium ions contained in an electrolyte and oxygen supplied from the outside. However, when a defect is present on a surface of the first carbon material, oxidation, cracking, or separation of the first carbon material may be more likely to occur during the formation and/or decomposition of a lithium oxide on a surface of the first carbon material. Accordingly, due to the increased occurrence of oxidation, cracking, or separation of the first carbon material, a side reaction between the first carbon material and the electrolyte is more likely to occur, and consequently, deterioration of the cathode is promoted. Accordingly, such deterioration of the cathode may then cause an increase in the generation of a gas such as carbon dioxide.

It has been advantageously discovered that when a defect on the surface of the first carbon material is coated with the conductive coating layer, a graphite-like structure may be formed on the surface of the first carbon material, and thus, defect-free crystalline carbon may be mainly exposed. In a region where such defect-free crystalline carbon is exposed, oxidation, cracking, or separation of the first carbon material may be suppressed during formation and/or decomposition of a lithium oxide, and accordingly, a side reaction between the first carbon material and the electrolyte is less likely to occur. As a consequence, deterioration of the cathode may be suppressed. In this regard, the surface of the first carbon material may be modified by the conductive coating layer.

In addition, the conductive coating layer (i.e., non-insulating coating layer) is different from an insulating coating layer in terms of conductivity, and accordingly, an increase in internal resistance of the cathode including the first carbon material may be suppressed. Thus, despite the addition of the conductive coating layer on the first carbon material, the increase in internal resistance of the cathode may be suppressed so that reversibility of an electrochemical reaction in the lithium air battery including the cathode may be maintained. For example, an insulating coating layer may substantially seal the surface of the first carbon material with an insulating material such that a reaction between lithium ions and oxygen may be prevented on the surface of the first carbon material. In such a case, the internal resistance of the cathode including the first carbon material on which the insulating coating layer is disposed may significantly increase, and thus, charge/discharge characteristics, such as battery capacity and lifespan characteristics, of the lithium air battery including the cathode may be significantly degraded.

In addition, within ranges of operating voltage and current capacity of lithium air batteries, the conductive coating layer is not involved in an electrochemical reaction and does not react with an electrolyte. Thus, the conductive coating layer may not be associated with the formation of an alloy of lithium during charging/discharging of the lithium air battery, and furthermore, does not react with oxygen and an electrolyte. That is, the conductive coating layer does not react with lithium, oxygen, and/or an electrolyte, and serves as an electrical conductor and/or an ionic conductor. In other words, the metal-containing semiconductor included in the non-insulating, conductive coating layer is not involved in oxidation and/or reduction of oxygen, i.e., an electrochemical reaction, and furthermore, does not react with an electrolyte. That is, the metal-containing semiconductor included in the conductive coating layer does not act as a catalyst to facilitate oxidation and/or reduction of oxygen.

The conductive coating layer may be subjected to complexation with the core in the cathode. For example, the conductive coating layer may be connected to the core via chemical or mechanochemical binding, rather than through simple mixing. In this regard, the carbon composite including the core and the non-insulating coating layer may be distinguished from a simple mixture of a core and a non-insulating material.

The metal-containing semiconductor in the cathode may include a metal element belonging to Groups 2 to 16 of the Periodic Table of the Elements. For example, the metal-containing semiconductor in the cathode may include: a semiconductor including an element belonging to Group 14, a semiconductor including an element belonging to Group 15, a semiconductor including an element belonging to Group 16, a semiconductor including elements belonging to Groups 13 and 15, a semiconductor including elements belonging to Groups 12 and 16 (i.e., a semiconductor including an element belonging to Group 12 and an element belonging to Group 16), a semiconductor including elements belonging to Groups 11 and 17, a semiconductor including elements belonging to Groups 14 and 16, a semiconductor including elements belonging to Groups 15 and 16, a semiconductor including elements belonging to Groups 12 and 15, and a semiconductor including elements belonging to Groups 11, 13, and 16 (i.e., a semiconductor including an element belonging to Group 13, an element belonging to Group 12, and an element belonging to Group 16). For example, the metal-containing semiconductor in the cathode may include an oxide of a Group 2 to Group 16 metal, a sulfide of a Group 2 to Group 16 metal, a nitride of a Group 2 to Group 16 metal, a nitrogen oxide of a Group 2 to Group 16 metal, a phosphide of a Group 2 to Group 16 metal, and an arsenide of a Groups 2 to Group 16 metal.

For example, the metal-containing semiconductor in the cathode may include ZnₐO_{b} (where 0<a≦2 and 0<b≦2), SnₐO_{b} (where 0<a≦2 and 0<b≦2), SrₐTi_{b}O_{c} (where 0<a≦2, 0<b≦2, and 0<c≦2), TiₐO_{b} (where 0<a≦2 and 2≦b≦4), BaₐTi_{b}O_{c} (where 0<a≦2, 0<b≦2, and 2<c≦4), CuₐO_{b} (where 1<a≦3 and 0<b≦2), CuₐO_{b} (where 0<a≦2 and 0<b≦2), BiₐO_{b} (where 1≦a≦3 and 2≦b≦4), FeₐS_{b} (where 0<a≦2 and 1 ≦b≦3), SnₐS_{b} (where 0<a≦2 and 0<b≦2), BiₐS_{b} (where 1 ≦a≦3 and 2≦b≦4), BiₐSe_{b} (where 1≦a≦3 and 2≦b≦4), BiₐTe_{b (where} 1≦a≦3 and 2≦b≦4), SnₐS_{b} (where 0<a≦2 and 1≦b≦3), PbₐS_{b} (where 0<a≦2 and 0<b≦2), ZnₐS_{b} (where 0<a≦2 and 0<b≦2), MoₐS_{b} (where 0<a≦2 and 1≦b≦3), PbₐTe_{b} (where 0<a≦2 and 0<b≦2), SnₐTe_{b} (where 0<a≦2 and 0<b≦2), GaₐN_{b} (where 0<a≦2 and 0<b≦2), GaₐP_{b} (where 0<a≦2 and 0<b≦2), BₐP_{b} (where 0<a≦2 and 0<b≦2), BaₐS_{b} (where 0<a≦2 and 0<b≦2), GaₐAs_{b} (where 0<a≦2 and 0<b≦2), ZnₐSe_{b} (where 0<a≦2 and 0<b≦2), ZnₐTe_{b} (where 0<a≦2 and 0<b≦2), CdₐTe_{b} (where 0<a≦2 and 0<b≦2), CdₐSe_{b} (where 0<a≦2 and 0<b≦2), or a combination thereof. For example, in the cathode, the metal-containing semiconductor may include ZnO, SnO, SrTiO, TiO₂, BaTiO₃, Cu₂O, CuO, Bi₂O₃, FeS₂, SnS, Bi₂S₃, Bi₂Se₃, Bi₂Te₃, SnS₂, PbS, ZnS, MoS₂, PbTe, SnTe, GaN, GaP, BP, BaS, GaAs, ZnSe, ZnTe, CdTe, CdSe, or a combination thereof, but examples are not limited thereto. Any material that is not an insulator may be used as the metal-containing semiconductor.

The metal-containing semiconductor in the cathode may have a band gap energy (e.g. an energy bandgap) of about 5.0 electron volts (eV) or less. For example, the metal-containing semiconductor in the cathode may have a band gap energy in a range from greater than about 0 eV to less than about 5.0 eV. For example, the metal-containing semiconductor in the cathode may have a band gap energy in a range from about 1.0 eV to about 4.5 eV. For example, the metal-containing semiconductor in the cathode may have a band gap energy in a range from about 1.5 eV to about 4.0 eV. For example, the metal-containing semiconductor in the cathode may have a band gap energy in a range from about 2.0 eV to about 4.0 eV. For example, the metal-containing semiconductor in the cathode may have a band gap energy in a range from about 2.5 eV to about 4.0 eV. For example, the metal-containing semiconductor in the cathode may have a band gap energy in a range from about 3.0 eV to about 4.0 eV. The band gap energy is an energy difference between a between a top of a valence band and a bottom of a conduction band. When a material has a band gap energy of greater than 5 eV, the material may be considered to be an insulator. Since an insulator has a completely empty conduction band at room temperature, no current flows. For example, Al₂O₃ has an energy bandgap of about 8.4 eV, that is, Al₂O₃ is an insulator. When a material has a band gap energy of 5 eV or less, the material is considered to be a semiconductor. In the semiconductor, electrons may partially fill a conduction band, and thus, current flows to a limited extent. For example, ZnO has an energy bandgap of about 3.3 eV while ZnS has an energy bandgap in a range from about 3.54 eV to about 3.91 eV. Since a valence band and a conduction band overlap each other in a conductor band, an energy bandgap of the conductor may be about 0 eV.

The metal-containing semiconductor in the cathode may have a resistivity, e.g., a volume resistivity, of about 1×10⁷ ohm centimeters (·cm) or less at a temperature of 20° C. For example, the metal-containing semiconductor in the cathode may have resistivity of about 1×10⁶ Ω·cm or less at a temperature of 20° C. For example, the metal-containing semiconductor in the cathode may have a resistivity of about 1×10⁵ Ω·cm or less at a temperature of 20° C. For example, the metal-containing semiconductor in the cathode may have a resistivity of about 1×10⁴ Ω·cm or less at a temperature of 20° C. For example, the metal-containing semiconductor in the cathode may have a resistivity of about 1×10³ Ω·cm or less at a temperature of 20° C. For example, the metal-containing semiconductor in the cathode may have a resistivity of about 800 Ω·cm or less at a temperature of 20° C. For example, the metal-containing semiconductor in the cathode may have a resistivity of about 600 Ω·cm or less at a temperature of 20° C. For example, the metal-containing semiconductor in the cathode may have resistivity of about 0.001 Ω·cm or greater at a temperature of 20° C. For example, the metal-containing semiconductor in the cathode may have a resistivity of about 0.01 Ω·cm or greater at a temperature of 20° C. For example, the metal-containing semiconductor in the cathode may have a resistivity of about 0.1 Ω·cm or greater at a temperature of 20° C. For example, the metal-containing semiconductor in the cathode may have a resistivity of about 1 Ω·cm or greater at a temperature of 20° C. For example, the metal-containing semiconductor in the cathode may have a resistivity of about 10 Ω·cm or greater at a temperature of 20° C. For example, the metal-containing semiconductor in the cathode may have a resistivity of about 50 Ω·cm or greater at a temperature of 20° C. For example, the metal-containing semiconductor in the cathode may have a resistivity of about 100 Ω·cm or greater at a temperature of 20° C. For example, Al₂O₃ may have a resistivity in a range from about 10¹¹ Ω·cm to about 10¹⁴ Ω·cm, and ZnO may have a resistivity of about 380 Ω·cm or less.

A thickness of the conductive coating layer (i.e., non-insulating coating layer) in the cathode may be about 20 nanometers (nm) or less. For example, a thickness of the conductive coating layer in the cathode may be about 10 nm or less. For example, a thickness of the conductive coating layer in the cathode may be about 8 nm or less. For example, a thickness of the conductive coating layer in the cathode may be about 5 nm or less. For example, a thickness of the conductive coating layer in the cathode may be about 4 nm or less. For example, a thickness of the conductive coating layer in the cathode may be about 3 nm or less. For example, a thickness of the conductive coating layer in the cathode may be about 2.5 nm or less. For example, a thickness of the conductive coating layer in the cathode may be about 2 nm or less. For example, a thickness of the conductive coating layer in the cathode may be about 1.5 nm or less. For example, a thickness of the conductive coating layer in the cathode may be about 1 nm or less. For example, a thickness of the conductive coating layer in the cathode may be about 0.5 nm or less. For example, a thickness of the non-insulating coating layer in the cathode may be about 0.1 nm or greater. When the thickness of the conductive coating layer is too large, conductivity of the carbon composite may be reduced, and accordingly, internal resistance of the lithium air battery employing the cathode including the carbon composite may increase, thereby degrading charge/discharge characteristics of the lithium air battery.

The conductive coating layer may be disposed discontinuously on the core in the cathode. For example, the non-insulating coating layer may be disposed on the core in a sea island form. For example, the non-insulating coating layer may be mainly disposed on a portion where a defect of the first carbon material is present, and may not be disposed on a portion where defectless crystalline carbon is present. The discontinuous deposition of the non-insulating coating layer on the core may minimize degradation of conductivity of the carbon composite including the non-insulating coating layer.

In addition, in the cathode, the conductive coating layer may be disposed on the core. For example, the conductive coating layer may be disposed on an entire surface of the core or on at least a portion of the surface of the core. For example, about 0.01% or greater of the core surface may be coated with the conductive coating layer, based on a total surface of the core. For example, about 0.05% or greater of the core surface may be coated with the conductive coating layer. For example, about 0.1% or greater of the core surface may be coated with the conductive coating layer. For example, about 0.5% or greater of the core surface may be coated with the conductive coating layer. For example, about 1.0% or greater of the core surface may be coated with the conductive coating layer. For example, about 5% or greater of the core surface may be coated with the conductive coating layer. For example, about 10% or greater of the core surface may be coated with the conductive coating layer. For example, about 90% or less of the core surface may be coated with the conductive coating layer. For example, about 80% or less of the core surface may be coated with the conductive coating layer. For example, about 70% or less of the core surface may be coated with the conductive coating layer. For example, about 60% or less of the core surface may be coated with the conductive coating layer. For example, about 50% or less of the core surface may be coated with the conductive coating layer.

When an area of the surface of the core which is coated with the conductive coating layer is too small, it may be difficult to effectively repair a defect present on the surface of the first carbon material. However, when an area of the surface of the core which is coated with the conductive coating layer is too large, most of the surface of the first carbon material may be coated with the coating layer, thereby reducing the total conductivity of the carbon composite.

In the cathode, the core including the first carbon material may have a structure including a spherical form, a rod form, a plate form, a tube form, or a combination thereof, but the structure of the core is not limited thereto. Any structure suitable for the core may be used. For example, the first carbon material may be a porous material having a large specific surface area and including pores.

In the cathode, the first carbon material may include carbon black, Ketjen black, acetylene black, natural graphite, artificial graphite, expanded graphite, graphene, graphene oxide, fullerene soot, mesocarbon microbead (MCMB), carbon nanotube (CNT), carbon nanofiber, carbon nanobelt, soft carbon, hard carbon, pitch carbon, mesophase pitch carbide, sintered coke, or a combination thereof, but the first carbon material is not limited thereto. Any material suitable as the first carbon material may be used.

In the cathode, the first carbon material may include crystalline carbon. The inclusion of the crystalline carbon in the first carbon material may reduce a surface defect thereof. Accordingly, during charging/discharging of the battery, deterioration of the carbon composite including the first carbon material and the conductive coating layer may be suppressed. For example, a degree of crystallinity of the first carbon material may be about 50% or greater. The term “degree of crystallinity” as used herein refers to a percentage ratio of the crystalline carbon to the first carbon material. For example, a degree of crystallinity of the first carbon material may be about 50.5% or greater. For example, a degree of crystallinity of the first carbon material may be about 51% or greater. For example, a degree of crystallinity of the first carbon material may be about 51.5% or greater. For example, a degree of crystallinity of the first carbon material may be about 52% or greater. For example, the first carbon material may not be amorphous carbon.

In a Raman spectrum of the carbon composite included in the cathode, a ratio of D-band intensity (I_{D}) to G-band intensity (I_{G}), i.e., an intensity ratio (or a height ratio) of I_{D} to I_{G} (I_{D}/I_{G}), with respect to the first carbon material may be about 1.0 or less. For example, in a Raman spectrum of the carbon composite included in the cathode, the intensity ratio of I_{D} to I_{G} (I_{D}/I_{G}) may be about 0.99 or less. For example, in a Raman spectrum of the carbon composite included in the cathode, the intensity ratio of I_{D} to I_{G} (I_{D}/I_{G}) may be about 0.98 or less. For example, in a Raman spectrum of the carbon composite included in the cathode, the intensity ratio of I_{D} to I_{G} (I_{D}/I_{G}) may be about 0.97 or less. For example, in a Raman spectrum of the carbon composite included in the cathode, the intensity ratio of I_{D} to I_{G} (I_{D}/I_{G}) may be about 0.96 or less. For example, in a Raman spectrum of the carbon composite included in the cathode, the intensity ratio of I_{D} to I_{G} (I_{D}/I_{G}) may be about 0.95 or less. For example, in a Raman spectrum of the carbon composite included in the cathode, the intensity ratio of I_{D} to I_{G} (I_{D}/I_{G}) may be about 0.90 or less. For example, in a Raman spectrum of the carbon composite included in the cathode, the intensity ratio of I_{D} to I_{G} (I_{D}/I_{G}) may be about 0.85 or less. For example, in a Raman spectrum of the carbon composite included in the cathode, the intensity ratio of I_{D} to I_{G} (I_{D}/I_{G}) may be about 0.80 or less. For example, in a Raman spectrum of the carbon composite included in the cathode, the intensity ratio of I_{D} to I_{G} (I_{D}/I_{G}) may be about 0.75 or less. The term “I_{D}” as used herein refers to a peak of a D band measured around 1353 cm⁻¹ in a Raman spectrum and having a diamond structure derived from a surface defect or a sp³ orbital of carbon. The term “I_{G}” as used herein refers to a peak of a G band measured around 1583 cm⁻¹ in a Raman spectrum and having a graphite structure formed of a sp² orbital of carbon. The intensity ratio of I_{D} to I_{G} (I_{D}/I_{G}) is used as a measure indicating a degree of crystallinity of the first carbon material. For example, when the intensity ratio (I_{D}/I_{G}) of the first carbon material is 1, the first carbon material is meant to have a degree of crystallinity of about 50%. The smaller the intensity ratio (I_{D}/I_{G}) of the first carbon material, the greater a degree of crystallinity of the carbon composite.

In the cathode, the carbon composite does not include a metal or a metal oxide catalyst for oxidation or reduction of oxygen. For example, the carbon composite may include the core including the first carbon material and the conductive coating layer (i.e., non-insulating coating layer) including the metal-containing semiconductor disposed on the core, but may not further include a metal and/or metal oxide catalyst in the core or in the non-insulating coating layer, wherein the metal/metal oxide catalyst is involved in the oxidation and/or reduction of oxygen through an electrochemical reaction. That is, the metal/metal oxide catalyst involved in oxidation/reduction of oxygen may not be additionally disposed on the core or the non-insulating coating layer of the carbon composite. Thus, even if the carbon composite of the cathode does not include the metal/metal oxide catalyst involved in oxidation/reduction of oxygen, the cathode and the lithium air battery including the cathode may sufficiently exhibit charge/discharge characteristics of the battery in consideration of oxidation/reduction of oxygen. Not including the metal/metal oxide catalyst in the carbon composite indicates a case where the metal/metal oxide catalyst is just disposed on the carbon composite, i.e., on a surface of the core and/or on a surface of the conductive coating layer of the carbon composite but the metal/metal oxide catalyst may not be subjected to complexation with the core and/or with the conductive (non-insulating) coating layer. The term “composite” or “complexation” as used herein refers to a case when a plurality of materials are connected via chemical bonds and/or a mechanochemical bonds. Here, the connection does not include a physical connection via physical binding, such as, for example, through van der Waals' attraction by simple mixing. Thus, when the carbon composite is combined as a simple mixture (e.g., a blend) with the metal/metal oxide catalyst in the cathode, the metal/metal oxide catalyst is not be included in the carbon composite. For example, the metal/metal oxide nanoparticle catalyst for oxidation/reduction of oxygen may not be included on the surface of the carbon composite as a part of the carbon composite by complexation.

In the cathode, the core may include a second carbon material, which is a product of heat treatment of the first carbon material. For example, the core may include a second carbon material, which is a sintered product of the first carbon material and which has an increased degree of crystallinity and a reduced defect as a result of the heat treatment performed on the first carbon material

The heat treatment of the first carbon material may be performed at a temperature in a range from about 700° C. to about 2,500° C. For example, the heat treatment of the first carbon material may be performed at a temperature in a range from about 1,000° C. to about 2,500° C. For example, the heat treatment of the first carbon material may be performed at a temperature in a range from about 1,500° C. to about 2,500° C. For example, the heat treatment of the first carbon material may be performed at a temperature in a range from about 1,700° C. to about 2,300° C. For example, the heat treatment of the first carbon material may be performed at a temperature in a range from about 1,800° C. to about 2,200° C. When the heat treatment of the first carbon material is performed at a temperature within the above ranges, the second carbon material may have improved crystallinity and a reduced surface defect.

The heat treatment of the first carbon material may be performed for about 30 minutes to about 24 hours. For example, the heat treatment of the first carbon material may be performed for about 1 hour to about 10 hours. For example, the heat treatment of the first carbon material may be performed for about 1 hour to about 5 hours. When the heat treatment of the first carbon material is performed for a period of time within the above ranges, the second carbon material may have improved crystallinity and a reduced surface defect.

As a result of the heat treatment, the second carbon material may have a reduced surface defect, and accordingly, the second carbon material may have a smaller specific surface area than the first carbon material. For example, the specific surface area of the second carbon material may be about 95% or less of the specific surface area of the first carbon material. For example, the specific surface area of the second carbon material may be about 90% or less of the specific surface area of the first carbon material. For example, the specific surface area of the second carbon material may be about 85% or less of the specific surface area of the first carbon material. For example, the specific surface area of the second carbon material may be about 60% or more of the specific surface area of the first carbon material. For example, the specific surface area of the second carbon material may be about 65% or more of the specific surface area of the first carbon material. For example, the specific surface area of the second carbon material may be about 70% or more of the specific surface area of the first carbon material. For example, the specific surface area of the second carbon material may be about 75% or more of the specific surface area of the first carbon material. For example, the specific surface area of the second carbon material may be in a range of about 60% to about 95%, or about 70% to about 90%, or about 75% to about 85% of the specific surface area of the first carbon material. When the specific surface area of the second carbon material is within the above ranges relative to the first carbon material, the second carbon material may effectively reduce a defect.

By the heat treatment, a ratio of the D-band intensity to the G-band intensity, i.e., intensity ratio of I_{D} to I_{G} (or a height ratio) (I_{D}/I_{G}) in a Raman spectrum of the second carbon material may be reduced compared to that of the first carbon material. For example, the intensity ratio of I_{D} to I_{G} (I_{D}/I_{G}) in a Raman spectrum of the second carbon material may be about 99% or less of the intensity ratio of I_{D} to I_{G} of the first carbon material. For example, the intensity ratio of I_{D} to I_{G} (I_{D}/I_{G}) in a Raman spectrum of the second carbon material may be about 97% or less of the intensity ratio of I_{D} to I_{G} of the first carbon material. For example, the intensity ratio of I_{D} to I_{G} (I_{D}/I_{G}) in a Raman spectrum of the second carbon material may be about 95% or less of the intensity ratio of I_{D} to I_{G} of the first carbon material. For example, the intensity ratio of I_{D} to I_{G} (I_{D}/I_{G}) in a Raman spectrum of the second carbon material may be about 93% or less of the intensity ratio of I_{D} to I_{G} of the first carbon material. For example, the intensity ratio of I_{D} to I_{G} (I_{D}/I_{G}) in a Raman spectrum of the second carbon material may be about 90% or less of the intensity ratio of I_{D} to I_{G} of the first carbon material. When the intensity ratio of the second carbon material is within the above ranges, the second carbon material may have significantly improved crystallinity. Accordingly, the second carbon material may have the same degree of crystallinity as the first carbon material or a higher degree of crystallinity than the first carbon material.

In a lithium air battery including the cathode, when measured by charging/discharging the air battery to a cut-off voltage of 2.0 V versus lithium metal, a number of cycles at which a discharge capacity of the lithium air battery is maintained at about 80% or more of a discharge capacity at the first cycle may be greater than 20. For example, when measured by charging/discharging the air battery to a cut-off voltage of 2.0 V versus lithium metal, the number of cycles at which a discharge capacity of the lithium air battery is maintained at about 80% or more of a discharge capacity at the first cycle may be 30 or greater. For example, when measured by charging/discharging the air battery to a cut-off voltage of 2.0 V versus lithium metal, the number of cycles at which a discharge capacity of the lithium air battery including the cathode during charging and discharging is maintained at about 80% or more of a discharge capacity at the first cycle may be 40 or greater. For example, when measured by charging/discharging the air battery to a cut-off voltage of 2.0 V versus lithium metal, the number of cycles at which a discharge capacity of the lithium air battery is maintained at about 80% or more of a discharge capacity at the first cycle may be 50 or greater. For example, when measured by charging/discharging the air battery to a cut-off voltage of 2.0 V versus lithium metal, the number of cycles at which a discharge capacity of the lithium air battery is maintained at about 80% or more of a discharge capacity at the first cycle may be 60 or greater. For example, when measured by charging/discharging the air battery to a cut-off voltage of 2.0 V versus lithium metal, the number of cycles at which a discharge capacity of the lithium air battery is maintained at about 80% or more of a discharge capacity at the first cycle may be 70 or greater. When the cathode includes the carbon composite, deterioration of the lithium air battery including the cathode may be suppressed, thereby significantly improving the lifespan characteristics of the battery.

In the lithium air battery including the cathode, an amount of carbon dioxide generated at a 15^{th} cycle during charging and discharging may be less than the amount of carbon dioxide generated at a 10^{th} cycle. The inclusion of the carbon composite in the cathode may suppress deterioration of the core including the carbon material during charging and discharging so that an amount of carbon dioxide generated by deterioration of the carbon surface may be reduced. For example, an initial side reaction occurs up until the 10^{th} cycle of the lithium air battery, and then, a surface of the carbon composite may be stabilized, thereby reducing additional deterioration thereof.

In the carbon composite included in the cathode, an amount of the metal-containing semiconductor may be in a range of about 1 part to about 300 parts by weight, about 1 part to about 250 parts by weight, about 2 parts to about 250 parts by weight, about 2 parts to about 200 parts by weight, about 3 parts to about 200 parts by weight, or about 3 parts to about 150 parts by weight, based on 100 parts by weight of the core including the first carbon material and the second carbon material.

In the cathode, a catalyst for oxidation and/or reduction of oxygen may be added. Examples of the catalyst include a precious metal catalyst, such as platinum, gold, silver, palladium, ruthenium, rhodium, and osmium; an oxide catalyst, such as manganese oxide, iron oxide, cobalt oxide, and nickel oxide; or an organic metal catalyst, such as cobalt phthalocyanine, but examples of the catalyst are not limited thereto. Any material that is suitable as a catalyst for oxidation/reduction of oxygen may be used. In addition, the catalyst may be supported on a carrier. Examples of the carrier include an oxide, a zeolite, a clay mineral, and carbon. The oxide may include at least one selected from alumina, silica, zirconium oxide, and titanium dioxide. The oxide may include a metal including cerium (Ce), praseodymium (Pr), samarium (Sm), europium (Eu), terbium (Tb), thulium (Tm), ytterbium (Yb), antimony (Sb), bismuth (Bi), vanadium (V), chromium (Cr), manganese (Mn), iron (Fe), cobalt (Co), nickel (Ni), copper (Cu), niobium (Nb), molybdenum (Mo), tungsten (W), or a combination thereof. Examples of the carbon include carbon black, such as Ketjen black, acetylene black, channel black, and lamp black; graphite, such as natural graphite, artificial graphite, and expanded graphite; activated carbon; and carbon fiber, but examples of the carrier are not limited thereto. Any material suitable as a carrier may be used. A combination comprising at least one of the foregoing may also be used. Optionally, the catalyst for oxidation/reduction of oxygen may be omitted.

The cathode may further include a binder. The binder may include a thermoplastic resin or a thermosetting resin. For example, the binder may include polyethylene, polypropylene, polytetrafluoroethylene (PTFE), polyvinylidene fluoride (PVDF), styrene-butadiene rubber, tetrafluoroethylene-perfluoroalkyl vinyl ether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoro propylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethylvinylether-tetrafluoroethylene copolymer, an ethylene-acrylic acid copolymer, or a combination thereof, but examples of the binder are not limited thereto. Any material suitable as a binder may be used.

The cathode may further include a solid electrolyte, a liquid electrolyte, or a combination thereof. The solid electrolyte refers to an electrolyte that maintains a constant shape at room temperature and has lithium ion conductivity. The liquid electrolyte refers to an electrolyte that has lithium ion conductivity, does not have a constant shape at room temperature, has a shape determined according to a shape of a container in which the liquid electrolyte is contained, and is fluid.

The solid electrolyte may include a solid electrolyte including a polymeric ionic liquid (PIL) and a lithium salt, a solid electrolyte including an ion conductive polymer and a lithium salt, or a solid electrolyte including an ion conductive inorganic material, but examples of the solid electrolyte are not limited thereto. Any material available suitable as a solid electrolyte may be used. A combination comprising at least one of the foregoing may also be used.

Examples of the lithium salt include LiPF₆, LiBF₄, LiSbF₆, LiAsF₆, LiCIO₄, LiCF₃SO₃, Li(CF₃SO₂)₂N, LiC₄F₉SO₃, LiAlO₂, LiAlCl₄, LiN(CₓF₂ₓ₊₁SO2)(C_{y}F_{2y+1}SO₂) (where x and y are each independently a natural number), LiCl, Lil, or a combination thereof, but are not limited thereto. Any material suitable for use as a lithium salt may be used.

The PIL may include a repeating unit including: i) a cation comprising an ammonium cation, a pyrrolidinium cation, a pyridinium cation, pyrimidinium cation, an imidazolium cation, a piperidinium cation, a pyrazolium cation, an oxazolium cation, a pyridazinium cation, a phosphonium cation, a sulfonium cation, a triazole cation, or a combination thereof and ii) an anion comprising BF₄—, PF₆—, AsF₆—, SbF₆—, AlCl₄—, HSO₄—, ClO₄, CH₃SO₃—, CF₃CO₂—, (CF₃SO₂)₂N—, Cl—, Br—, I—, BF₄—, SO₄⁻, PF₆—, CIO₄—, CF₃SO₃—, CF₃CO₂—, (C₂F₅SO₂)₂N—, (C₂F₅SO₂)(CF₃SO₂)N—, NO₃⁻, Al₂Cl₇^{-, AsF}₆³¹ , SbF₆⁻, CF₃COO⁻, CH₃COO⁻, CF₃SO₃⁻, 7 (CF₃SO₂)₃C⁻, (CF₃CF₂S0₂)₂N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂) ₂CH⁻, (SF₅)₃C⁻, (O(CF₃)₂C₂(CF₃)₂O)₂PO⁻, (CF₃SO₂)₂N⁻, or a combination thereof.

For example, the PIL may include poly(diallyldimethylammonium) (TFSI), poly(1-allyl-3-methylimidazolium trifluoromethanesulfonylimide), poly((N-methyl-N-propyl-3,5-dimethylene piperidinium bis(trifluoromethanesulfonyl)imide)), or a combination thereof.

The ion conductive polymer refers to a polymer including an ion conductive repeating unit as a main chain or a side chain. Any material having ionic conductivity may be used as the ion conductive repeating unit, and examples thereof include an alkylene oxide unit, such as ethylene oxide, and a hydrophilic unit. For example, the ion conductive polymer may include an ion conductive repeating unit including an ether monomer, an acryl monomer, a methacryl monomer, a siloxane monomer, or a combination thereof. For example, the ion conductive polymer may include polyethylene oxide, polypropylene oxide, poly(methyl methacrylate), polyethyl methacrylate, polydimethylsiloxane, poly(acrylic acid), poly(methacrylic acid), poly(methyl acrylate), polyethylacrylate, poly(2-ethyl-hexyl acrylate), poly(butylmethacrylate), poly(2-ethyl-hexyl-methacrylate), polydecylacrylate, polyethylene vinyl acetate, or a combination thereof. For example, as the ion conductive polymer, a polyethylene (PE) derivative, a polyethylene oxide (PEO) derivative, a polypropylene oxide (PPO) derivative, a phosphate ester polymer, polyvinyl alcohol (PVA), polyvinylidene fluoride (PVdF), a polymer containing an ionic dissociation group, such as Nafion substituted with lithium, or a combination thereof, but examples of the ion conductive polymer are not limited thereto. Any material that is suitable for use as the ion conductive polymer may be used. For example, the ion conductive polymer may include PEO, PVA, polyvinylpyrrolidone (PVP), polysulfone, or a combination thereof. For example, the solid electrolyte may be polyethylene oxide doped with a lithium salt.

The ion conductive inorganic material may include BaTiO₃, Pb(Zr,Ti)O₃ (PZT), Pb₁₋ₓLaₓZr_{1-y} Ti_{y}O₃ (PLZT)(where 0≦x<1 and 0≦y<1), Pb(Mg₃Nb_{2/3})O₃-PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, lithium phosphate (Li₃PO₄), lithium titanium phosphate (LiₓTi_{y}(PO₄)₃)(where 0<x<2 and 0<y<3), lithium aluminum titanium phosphate (LiₓAl_{y}Ti_{z}(PO₄)₃)(where 0<x<2, 0<y<1, and 0<z<3), Li_{1+x+y}(Al, Ga)ₓ(Ti, Ge)₂₋ₓSiP_{3-y}O₁₂ (where and lithium lanthanum titanate (LiₓLa_{y}TiO₃)(where 0<x<2 and 0<y<3), lithium germanium thiphosphate (LiₓGe_{y}P_{z}S_{w})(where 0<x<4, 0<y<1, 0<z<1, and 0<w<5), lithium nitride (LiₓN_{y})(where 0<x<4 and 0<y<2), SiS₂ glass (LiₓSi_{y}S_{z})(where 0<x<3,0<y<2, and 0<z<4), P₂S₅(LiₓP_{y}S_{z}, 0<x<3, 0<y<3, 0<z<7); Li₂O-based, LiF-based, LiOH-based, Li₂CO₃-based, LiA10₂-based, or Li₂O-A1₂0₃-SiO₂-P₂O₅-TiO₂-Ge0₂-based ceramics; and Garnet-based ceramics (Li₃₊ₓLa₃M₂O₁₂(M=Te, Nb, Zr), or a combination thereof.

The liquid electrolyte may be an organic-based electrolyte or a water-based electrolyte.

The organic-based electrolyte may include an aprotic solvent. Examples of the aprotic solvent include a carbonate-based solvent, an ester-based solvent, an ether-based solvent, a ketone-based solvent, or an alcohol-based solvent. The carbonate-based solvent may be dimethyl carbonate (DMC), diethyl carbonate (DEC), ethylmethyl carbonate (EMC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or tetraethylene glycol dimethyl ether (TEGDME). The ester-based solvent may be methyl acetate, ethyl acetate, n-propyl acetate, dimethylacetate, methylpropionate, ethylpropionate, y-butyrolactone, decanolide, valerolactone, mevalonolactone, or caprolactone. The ether solvent may be dibutyl ether, tetraglyme, diglyme, dimethoxyethane, 2-methyltetrahydrofuran, or tetrahydrofuran. The ketone-based solvent may be cyclohexanone. The alcohol-based solvent may be ethyl alcohol or isopropyl alcohol. However, examples of the aprotic solvent are not limited thereto. Any material that is suitable as the aprotic solvent may be used. A combination comprising at least one of the foregoing may also be used. In addition, the aprotic solvent may be a nitrile, e.g. R-CN≡N (wherein R is a C2-C20 linear, branched, or cyclic hydrocarbon group, which may include a double bond-aromatic ring or an ether bond), an amine such as dimethyl formamide, a dioxolane such as 1,3-dioxolane, or sulfolane. The aprotic solvent may be used alone or in a combination. When used in a combination, a mixing ratio may be appropriately adjusted according to performance of the battery, and such an adjustment may be determined by one of ordinary skill in the art without undue experimentation.

The organic-based electrolyte may include a salt of an alkali metal and/or an alkaline earth metal. The salt of the alkali metal and/or the alkaline earth metal may be dissolved in an organic solvent and may then serve as a source of ions for the alkali metal and/or the alkaline earth metal in the battery. For example, the organic-based electrolyte may catalyze the movement of ions of the alkali metal and/or the alkaline earth metal between the cathode and the anode. For example, cations of the salt of the alkali metal and/or the alkaline earth metal may include lithium ions, sodium ions, magnesium ions, potassium ions, rubidium ions, strontium ions, cesium ions, or barium ions. Anions of the salt included in the organic-based electrolyte may include PF₆^{-,} BF₄^{-, SbF}₆⁻, AsF₆⁻, C₄F₉SO₃⁻, ClO₄⁻, AlO₂⁻, AlCl₄⁻, CₓF₂ₓ₊₁SO₃⁻(wherein x is a natural number), (CₓF₂ₓ₊₁SO₂)(C_{y}F_{2y+1}SO₂)N⁻(wherein x and y are each a natural number), a halide, or a combination thereof. For example, the salt of the alkali metal and/or the alkaline earth metal may include LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiACl₄, LiN(CₓF₂ₓ₊₁SO₂)(C_{y}F_{2y+1}SO₂)(wherein x and y are each a natural number), LiF, LiBr, LiCI, Lil, lithium bis(oxalato) borate(LiBOB, LiB(C₂O₄)₂), or a combination thereof, but examples of the salt of the alkali metal and/or the alkaline earth metal are not limited thereto. Any material that is suitable as the salt of the alkali metal and/or the alkaline earth metal may be used. In the organic-based electrolyte, an amount of the salt of the alkali metal and/or the alkaline earth metal may be in a range of about 100 millimolar (mM) to about 10 molar (M). For example, the amount of the salt of the alkali metal and/or the alkaline earth metal may be in a arrange of about 250 mM to about 5 M, or may be in a range of about 500 mM to about 2 M. However, the amount of the salt of the alkali metal and/or the alkaline earth metal is not limited thereto, and may be within any range that enables the organic-based electrolyte to effectively transfer lithium ions and/or electrons during charging/discharging of the battery.

The organic electrolyte may include an ionic liquid. The ionic liquid may include a compound including a cation, such as substituted linear or branched ammonium, imidazolium, pyrrolidinium, or piperidinium, and an anion, such as PF₆⁻, BF₄⁻, CF₃SO₃⁻, (CF₃SO₂)₂N⁻, (C₂F₅SO₂)₂N⁻, (C₂F₅SO₂)₂N⁻, or (CN)₂N⁻. For example, the ionic liquid may include [emim](Cl/AlCl₃ (emim=ethyl methyl imidazolium), [bmpyr]NTf2 (bmpyr=butyl methyl pyridinium; NTf=trifluoromethanesulfonimide), [bpy]Br/AlCl₃ (bpy=4, 4′-bipyridine), [choline]Cl/CrCl₃6H₂O, [Hpy(CH₂)₃pyH][NTf₂]₂ (py=pyridine), [emim]OTf/[hmim]l (hmim=hexyl methyl imidazolium), [choline]Cl/HOCH₂CH₂OH, [Et₂MeN(CH₂CH₂OMe)]BF₄ (Et=ethyl, Me=methyl), [Bu₃PCH₂CH₂C₈F₁₇]OTf (OTf=trifluoromethane sulfonate; Bu=butyl), [bmim]PF₆ (bmim=butyl methyl imidazolium), [bmim]BF₄, [omim]PF₆ (omim=octyl methyl imidazolium), [Oct₃PC₁₈H₃₇]l (Oct=octyl), [NC(CH₂)₃mim]NTf₂ (mim=methyl imidazolium), [Pr₄N][B(CN)₄], [bmim]NTf₂, [bmim]Cl, [bmim][Me(OCH₂CH₂)₂OSO₃], [PhCH₂mim]OTf, [Me₃NCH(Me)CH(OH)Ph] NTf₂ (Ph=phenyl), [pmim][(HO)₂PO₂] (pmim=propyl methyl imidazolium), [b(6-Me)quin]NTf₂ (bquin=butyl quinolinium, [bmim][Cu₂Cl₃], [C₁₈H₃₇OCH₂mim]BF₄ (mim=methyl imidazolium), [heim]PF₆ (heim=hexyl ethyl imidazolium), [mim(CH₂CH₂O)₂CH₂CH₂mim][NTf₂]₂ (mim=methyl imidazolium), [obim]PF₆ (obim =octyl butyl imidazolium), [oquin]NTf₂(oquin=octyl quinolinium), [hmim][PF₃(C₂F₅)₃], [C₁₄H₂₉mim]Br(mim=methyl imidazolium), [Me₂N(C₁₂H₂₅)₂]NO₃, [emim]BF₄, [mm(3-NO₂) im][dinitrotriazolate], [MeN(CH₂CH₂OH)₃], [MeOSO₃], [Hex₃PC₁₄H₂₉]NTf₂ (Hex=hexyl), [emim][EtOSO₃], [choline][ibuprofenate], [emim]NTf₂, [emim][(EtO)₂PO₂], or [emim]Cl/CrCl₂ [Hex₃PC₁₄H₂₉]N(CN)₂ but examples of the ionic liquid are not limited thereto. Any material that is suitable as the ionic liquid may be used. A combination comprising at least one of the foregoing may also be used. For example, the ionic liquid may include N,N-diethyl-N-methyl-N-(2-methoxyethyl)ammonium tetraborate ([DEME][BF₄]), diethylmethylammonium trifluoromethanesulfonate ([dema][TfO]), dimethylpropylammonium trifluoromethanesulfonate ([dmpa][TfO]), diethylmethylammonium trifluoromethanesulfonylimide ([DEME][TFSI]), methyl-propyl-piperidinium trifluoromethanesulfonaylimide ([mpp][TFSI]), or a combination thereof, but examples of the ionic liquid are not limited thereto. Any material that is suitable as the ionic liquid may be used.

The water-based electrolyte may be prepared by adding the salt of alkali metal and/or the alkaline earth metal to a water-containing solvent.

The cathode may be prepared in a way that, for example, a cathode slurry is prepared, in which carbon composite is mixed with a binder and a suitable solvent is added to the mixture, and then, a surface of a current collector is coated with the cathode slurry and then dried. Alternatively, the cathode may be prepared by compression molding in order to improve electrode density. In addition, the cathode may selectively include a lithium oxide or a lithium halide-based redox mediator.

A lithium air battery according to an example embodiment may include the cathode.

The lithium air battery may include: the cathode; an anode that allows deposition and dissolution of lithium; and an electrolyte membrane disposed between the cathode and the anode.

As the anode allows deposition and dissolution of lithium, the lithium air battery may use a lithium metal thin film as the anode. In the case when a lithium metal thin film is used as the anode, the lithium metal thin film may reduce a volume and a weight of a current collector, and in this regard, the lithium air battery may have increased energy density. Alternatively, the lithium metal thin film may be disposed on a conductive substrate which is a current collector. The lithium metal thin film may be formed integrally with a current collector. Such a current collector may include stainless steel, copper, nickel, iron, titanium, or a combination thereof, but the examples of the current collector are not limited thereto. Any metallic substrate having excellent conductivity may be used. In addition, as the anode that allows deposition and dissolution of lithium, an alloy of lithium metal with a different anode active material may be used. Such a different anode active material may be a metal alloyable with lithium.

Examples of the metal alloyable with lithium are Si, Sn, Al, Ge, Pb, Bi, Sb, a Si-Y′ alloy (where Y′ is an alkali metal, an alkaline earth metal, a Group 13 element, a Group 14 element, a transition metal, a rare earth element, or a combination thereof, and Y′ is not Si), a Sn-Y′ alloy (where Y′ is an alkali metal, an alkaline earth metal, a Group 13 element, a Group 14 element, a transition metal, a rare earth element, or a combination thereof, and Y′ is not Sn), or a combination thereof. Y′ may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof. In some embodiments, Y may be magnesium (Mg), calcium (Ca), strontium (Sr), barium (Ba), radium (Ra), scandium (Sc), yttrium (Y), titanium (Ti), zirconium (Zr), chromium (Cr), molybdenum (Mo), tungsten (W), iron (Fe), lead (Pb), ruthenium (Ru), osmium (Os), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), or a combination thereof. For example, the metal alloyable with lithium may include a lithium-aluminum alloy, a lithium-silicon alloy, a lithium-tin alloy, a lithium-silver alloy, and a lithium-lead alloy.

A thickness of the anode may be about 10 micrometers (pm) or more. For example, the thickness of the anode may be in a range from about 10 μm to about 20 μm, about 20 μm to about 60 μm, about 60 μm to about 100 μm, about 100 μm to about 200 μm, about 200 μm to about 600 μm, about 600 μm to about 1,000 μm, about 1 millimeter (mm) to about 6 mm, about 6 mm to about 10 mm, about 10 mm to about 60 mm, about 60 mm to about 100 mm, and about 100 mm to about 600 mm.

The electrolyte membrane may be configured such that a liquid electrolyte may be injected into a separator.

Any composition may be used so long as it can withstand a range of usage of a separator to be used in the lithium air battery, and examples thereof include a polymeric non-woven fabric, such as a polypropylene non-woven fabric or a polyphenylene sulfide non-woven fabric, and a porous film of an olefin resin polyethylene, such as polypropylene. At least two compositions selected from the examples may be used in combination. For example, the separator may be formed of glass fiber. The separator may be omitted in the case when a lithium ion conductive solid electrolyte membrane described below is used.

The liquid electrolyte may be either an organic-based electrolyte or a water-based electrolyte. The water-based electrolyte may be the same as the electrolyte used in the preparation of the cathode.

Alternatively, the electrolyte membrane may be a lithium ion conductive solid electrolyte membrane. The lithium ion conductive solid electrolyte membrane may be additionally disposed on one side of the separator, or may be disposed in place of the separator. The lithium ion conductive solid electrolyte membrane may serve as a protection membrane that protects lithium included in the anode from directly reacting with impurities, such as moisture or oxygen, included in the water-based electrolyte. The lithium ion conductive solid electrolyte membrane may include lithium ion conductive glass, lithium ion conductive crystal (ceramic or glass-ceramic), or an inorganic material including a mixture of lithium ion conductive glass and lithium ion conductive crystal, but examples of the lithium ion conductive solid electrolyte membrane are not limited thereto. Any solid electrolyte membrane available in the art having lithium ion conductivity and capable of protecting the cathode (air electrode) and/or an anode may be used. In consideration of chemical stability, the lithium ion conductive solid electrolyte membrane may be a lithium ion conductive oxide. An example of the lithium ion conductive crystal includes Li_{1+x+y}(Al, Ga)ₓ(Ti, Ge)₂₋ₓSi_{y}P_{3-y}O₁₂ (where 0≦x≦1 and 0≦y≦1, for example, 0≦x≦0.4 and 0<y≦0.6 or 0.1≦x≦0.3 and 0.121 y≦4). Examples of the lithium ion conductive glass-ceramic include lithium-aluminum-germanium-phosphate (LAGP), lithium-aluminum-titanium-phosphate (LATP), and lithium-aluminum-titanium-silicon-phosphate (LATSP).

The lithium ion conductive solid electrolyte membrane may further include a polymeric solid electrolyte component, in addition to glass-ceramic components. Such a polymeric solid electrolyte component may be polyethylene oxide (PEO) doped with a lithium salt, and examples of the lithium salt include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, and LiACl₄.

The lithium ion conductive solid electrolyte membrane may further include an inorganic solid electrolyte component, in addition to glass-ceramic components. Examples of the inorganic solid electrolyte component include Cu₃N, Li₃N, and LiPON.

The lithium air battery may be prepared as follows.

First, the cathode including the carbon composite, the anode that allows deposition and dissolution of lithium, and the separator are prepared.

Next, the anode is mounted on one side of a case, the separator is mounted on the anode, and the cathode is mounted on the separator. Subsequently a porous current collector is disposed on the cathode, and a pressing member allowing air to reach the cathode (air electrode) is pressed to form a cell, thereby completing preparation of the lithium air battery. A liquid electrolyte including a lithium salt may be injected into the separator mounted on the anode during preparation of the lithium air battery. The case may be divided into an upper portion contacting the cathode (air electrode) and a lower portion contacting the anode. An insulating resin may be interposed between the upper and lower portions to electrically insulate the cathode (air electrode) and the anode. The lithium air battery is available either as a lithium primary battery or a lithium secondary battery. In addition, the lithium air battery may have any of various forms, and for example, may be in the form of a coin, a button, a sheet, a stack, a cylinder, a plane, or a horn, without limitation. Also, the lithium air battery may be applied to a large battery for electric vehicles.

FIG. 15 is a schematic diagram illustrating a lithium air battery 30. The lithium air battery 30 may include a cathode 36 using oxygen as an active material, an anode33, and an electrolyte membrane 34 disposed between the cathode 36 and the anode 33. The anode 33 may be disposed on an anode current collector 32. The electrolyte membrane 34 may be prepared by injecting a liquid electrolyte into a separator. A solid electrolyte membrane 35 may be disposed between the electrolyte membrane 34 and the cathode 36. The solid electrolyte membrane 35 may be omitted. A gas diffusion layer 37 may be disposed on the cathode 36. A pressing member 39 allowing air to reach the cathode 36 may be disposed on the gas diffusion layer 37, and a case 31 formed of an insulating resin material may be disposed between an nair supply unit comprising an air inlet 38a and an air outlet 38b and the anode current collector 32 to electrically separate the cathode 36 from the anode 33. Air is supplied through an air inlet 38a and discharged through an air outlet 38b. The lithium air battery 30 may be stored in a stainless steel reactor.

The term “air” as used here is not limited to atmospheric air, and may also refer to a combination of gases including oxygen, or pure oxygen gas. This broad definition of “air” also applies to other terms, including an air battery, air positive electrode, and the like.

A method of preparing a cathode according to an example embodiment may include: preparing a first carbon material; and preparing a carbon composite by disposing a conductive coating layer including a metal-containing semiconductor on the first carbon material. In the method of preparing the cathode, the deposition of the conductive (non-insulating) coating layer including the metal-containing semiconductor on the first carbon material may prevent the cathode from deterioration, and accordingly, a lithium air battery including the cathode may have improved lifespan characteristics.

In the method of preparing the cathode, the disposing of the conductive coating layer includes a deposition method, and the deposition method may include atomic layer deposition (ALD), physical vapor deposition (PVD), or chemical vapor deposition (CVD), but the deposition methods are not limited thereto. Any method available in the art may be used by which a thin film having a thickness of about 20 nm or less on a substrate may be prepared.

Types of the metal-containing semiconductor to be deposited may be the same as defined in connection with the cathode. A thickness or shape of the non-insulating coating layer may be also the same as defined in connection with the cathode.

In the method of preparing the cathode, heat treatment of the carbon composite including a first carbon material on which the conductive coating layer is disposed or a first carbon material on which the conductive coating layer is not disposed at a temperature in a range from about 700° C. to about 2,500° C. may be further added. The heat treatment performed on the first carbon material may improve crystallinity and reduce a surface defect thereof, and accordingly, durability of the carbon composite also improves. In this regard, the deterioration of the cathode including the carbon composite may be prevented, and lifespan characteristics of the lithium air battery including the cathode may further improve.

A temperature at which the heat treatment is performed may be in a range from about 700° C. to about 2,500° C. For example, the temperature at which the heat treatment is performed may be in a range from about 1,000° C. to about 2,500° C. For example, the temperature at which the heat treatment is performed may be in a range from about 1,500° C. to about 2,500° C. For example, temperature at which the heat treatment is performed may be in a range from about 1,700° C. to about 2,300° C. For example, temperature at which the heat treatment is performed may be in a range from about 1,800° C. to about 2,200° C. When the heat treatment is performed within the above ranges, a second carbon material may have improved crystallinity and a reduced surface defect.

The heat treatment may be performed for about 30 minutes to about 24 hours. For example, the heat treatment may be performed for about 1 hour to about 10 hours. For example, heat treatment may be performed for about 1 hour to about 5 hours. When the heat treatment is performed for a period of time within the above ranges, a second carbon material may have improved crystallinity and a significantly reduced surface defect.

The atmosphere in which the heat treatment is performed may be an inert gas atmosphere not including oxygen, but including N₂, Ar, or He.

Hereinafter, one or more embodiments will be described in detail with reference to the following examples. However, these examples are not intended to limit the scope of the one or more embodiments.

### EXAMPLES

### Preparation of Cathode

### Example 1: ZnO (0.5 nm)/CNT Carbon Composite Free standing film Cathode

A cathode was prepared by coating a free-standing carbon nanotube (CNT) film with ZnO using an atomic layer deposition (ALD) method.

A solution prepared by dispersing CNT powder (available from Hanhwa Chemical, Korea, CM250) in poly(styrenesulfonic acid) (PSS) was subjected to vacuum filtration to prepare a free-standing film. The prepared free-standing film was then vacuum-dried and heat-treated at a temperature of about 450° C. to remove all PSS therein, thereby preparing a free-standing film consisting of CNT only (hereinafter, referred to as a free-standing CNT film).

The ALD was performed in a continuous-flow stainless steel reactor. The free-standing CNT film was disposed on a stainless steel tray, and a stainless steel mesh cover was clamped over the tray to contain CNT film in a fixed bed while still providing access to ALD precursor vapors. The free-standing CNT film was held in the reactor at a temperature of 150° C. under a continuous flow of high-purity nitrogen carrier gas at a pressure of 1 torr for 30 minutes to outgas, thereby achieving thermal equilibrium. Here, one cycle of the ZnO-ALD used alternating exposures to diethylzinc and H₂O (vapor) at a temperature of 150° C. The ZnO-ALD was performed with a sequence of ZnO precursor exposure (0.5 sec)-N₂ purging (10 sec)-H₂O (vapor) exposure (1 sec)-N₂ purging (10 sec). The ZnO-ALD cycle was repeated for 8 cycles using the free-standing CNT film, thereby preparing a carbon composite cathode including the free-standing CNT film coated with ZnO. Here, a thickness of the coated ZnO was about 0.5 nm.

An amount of ZnO was about 8.8 weight percent (wt %) and an amount of the CNT film was about 91.2 wt %, based on the total weight of the carbon composite cathode.

### Example 2: ZnO (2.5 nm)/CNT Carbon Composite Free-Standing Film Cathode

ZnO was coated on a free-standing CNT film by using the ALD method in the same manner as in Example 1, except that coating was performed to a different thickness.

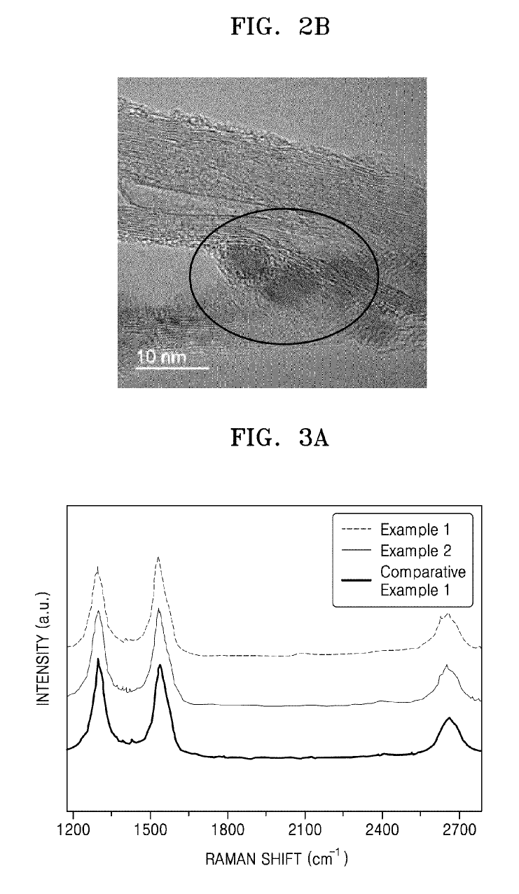

A thickness of the coated ZnO was about 2.5 nm. FIGS. 2A and 2B each show a transmission electron microscopic (TEM) image of CNT coated with ZnO to a thickness of 2.5 nm. As shown in FIGS. 2A and 2B, ZnO was coated on a free-standing CNT film.

An amount of ZnO was about 26.6 wt% and an amount of the CNT film was about 73.4 wt %, based on the total weight of the carbon composite cathode.

### Example 3: ZnO (10 nm)/CNT Carbon Composite Free-Standing Film Cathode

ZnO was coated on a free-standing CNT film using the ALD method in the same manner as in Example 1, except coating was performed to a different thickness.

A thickness of the coated ZnO was about 10 nm.

An amount of ZnO was about 59.4 wt % and an amount of the CNT film was about 40.6 wt %, based on the total weight of the carbon composite cathode.

### Example 4: ZnO (0.5 nm) /¹³C Carbon Composite Cathode

A cathode having 1 mg weight per area (cm²) was prepared as follows. Instead of using a free-standing CNT film, carbon (available from Sigma-Aldrich, USA 99%) and a binder (vinylidene fluoride-hexafluoropropylene copolymer, available as KYNAR® 2810) were mixed at a weight ratio of 9:1, the mixture was mixed with an N-methylpyrrolidone (NMP) solution, and then, a nickel-mesh substrate was coated with the resulting solution and dried to prepare a ¹³C film (i.e., ¹³C core).

ZnO was then coated on a ¹³C film by using the ALD method in the same manner as in Example 1, except that the ¹³C core was used. A coating method was the same as that used in Example 1.

A thickness of the coated ZnO was about 0.5 nm, and a specific surface area of non-heat-treated ¹³C carbon was about 194.7 square meters per gram (m²/g).

An amount of ZnO was about 14.0 wt % and an amount of ¹³C was about 86.0 wt %, based on the total weight of the carbon composite cathode.

### Example 5: ZnO (0.5 nm)/Heat-Treated ¹³C Carbon Composite Cathode

ZnO was then coated on a free-standing ¹³C film using the ALD method in the same manner as described in Example 1, except that heat-treated ¹³C (available from Sigma-Aldrich, USA 99%) was used instead of a free-standing CNT film.

Heat-treated ¹³C refers to graphitized ¹³C obtained by heat-treating ¹³C at a temperature of about 2,000° C. for 2 hours in a nitrogen atmosphere. The specific surface area of the heat-treated ¹³C carbon was about 181.1 m²/g. The ¹³C film used for heat treatment is the same as the ¹³C film prepared in Example 4.

An amount of ZnO was about 3.7 wt % and an amount of ¹³C was about 96.3 wt %, based on the total weight of the carbon composite cathode.

A thickness of the coated ZnO was about 0.5 nm.

Example 6: ZnS (0.5 nm)/CNT Carbon Composite Free-Standing Film Cathode

ZnS was coated on a free-standing CNT film using the ALD method in the same manner as in Example 1, except that diethylzinc, which is a ZnS precursor, and H₂S were used instead of diethylzinc, which is a ZnO precursor, and H₂O, respectively.

A thickness of the coated ZnO was about 0.5 nm.

### Example 7: SnS₂ (0.5 nm)/CNT Carbon Composite Free-Standing Film Cathode

SnS₂ was coated on a free-standing CNT film using the ALD method in the same manner as in Example 1, except that tetrakis(dimethlyamino)tin (IV), which is a SnS₂ precursor, and H₂S were used instead of diethylzinc, which is a ZnO precursor, and H₂O, respectively.

A thickness of the coated SnS₂ was about 0.5 nm.

### Example 8: TiO₂ (0.5 nm) /¹³C Carbon Composite Cathode

A cathode having 1 mg weight per area (cm²) was prepared as follows. Instead of using a free-standing CNT film, ¹³C (available from Sigma-Aldrich, USA 99%) and a carbon binder (vinylidne fluoride-hexafluoropropylene copolymer, available as KYNAR® 2810) were mixed at a ratio of 9:1, the mixture was mixed with NMP solution, and then, a nickel-mesh substrate was coated with the resulting solution and dried to prepare a ¹³C film (i.e., ¹³C core).

TiO₂ was then coated on a ¹³C film using the ALD method in the same manner as in Example 1, except that ¹³C carbon composite and TiO₂ was used. A coating method was the same as that used in Example 1.

A thickness of the coated TiO₂ was about 0.5 nm.

### Comparative Example 1: Free-Standing CNT Film Cathode

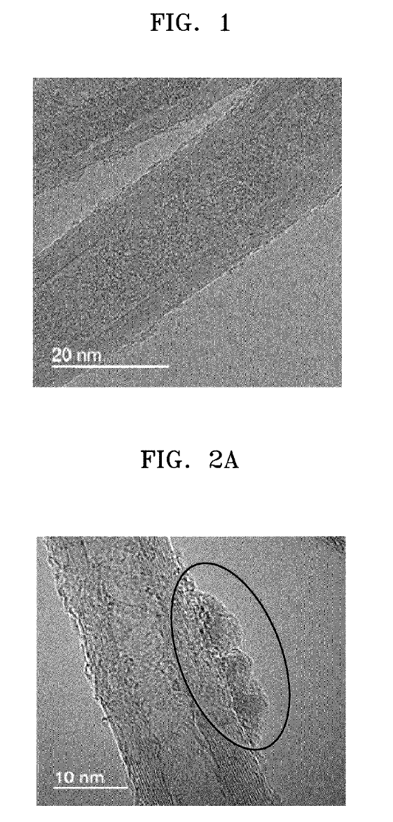

As a carbon material, the same free-standing CNT film of Example 1 was used without undergoing coating with ZnO. FIG. 1 is a TEM image showing CNTs included in the free-standing CNT film used herein.

### Comparative Example 2: ¹³C Film Cathode

As a carbon material, the same ¹³C of Example 4 was used without undergoing coating with ZnO.

### Comparative Example 3: Al₂O₃ 0.5 nm/CNT Carbon Composite Free-Standing Film Cathode

An insulating material, Al₂O₃, was coated on a free-standing CNT film using the ALD method in the same manner as in Example 1, except that trimethylaluminum (TMA), which is an Al₂O₃ precursor, was used instead of diethylzinc, which is a ZnO precursor.

### Preparation of Lithium Air Battery

### Example 9

The cathode of Example 1, a lithium metal thin film as an anode, and a glass fiber separator, which is a glass fiber material used as a separator (WHATMAN® GF/D microfiber filter paper, 2.7 μm pore size), were used, and in addition, 150 microliters (μL) of an electrolyte solution in which 1 M lithium bis(trifluoromethanesulfonyl)imide (LiTFSI) was dissolved in tetra(ethylene glycol)dimethylether) (TEGDME) was injected into the separator.

The lithium metal thin film used as the anode was mounted on a stainless steel case, the separator was mounted on the anode, the cathode of Example 1 was mounted on the separator, and a gas diffusion layer (available from SGL Company, BA35) was mounted on the cathode. Subsequently, a stainless steel mesh was disposed on the gas diffusion layer, and a pressing member allowing air to reach the cathode was applied thereto to fix a cell, thereby completing preparation of a lithium air battery. The stainless steel case may be divided into an upper portion contacting the cathode and a lower portion contacting the anode, and an insulating resin may be interposed between the upper and lower portions to electrically insulate the cathode and the anode. FIG. 1 shows a schematic structure of a lithium air battery according to an embodiment.

### Examples 10 to 16

Lithium air batteries were each prepared in the same manner as in Example 9, except that the cathodes of Examples 2 to 8 were used.

### Comparative Examples 4 to 6

Lithium air batteries were each prepared in the same manner as in Example 9, except that the cathodes of Comparative Examples 1 to 3 were used.

### Evaluation Example 1: Measurement of Raman Spectrum

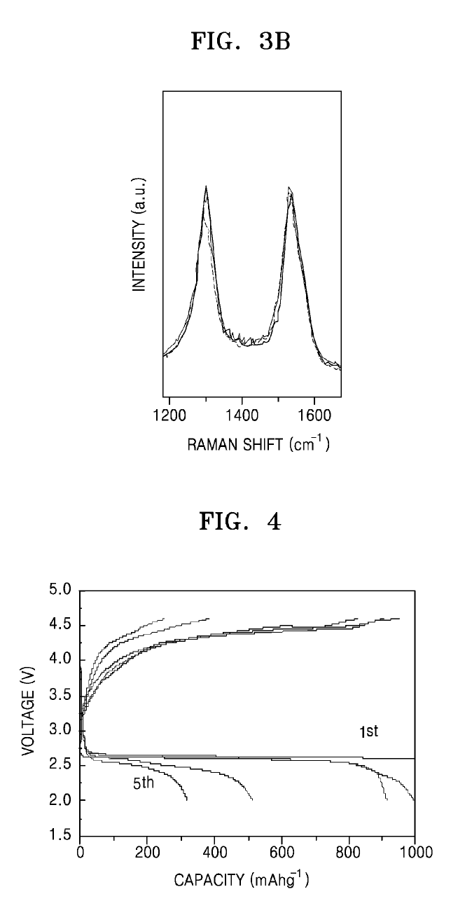

Raman spectra of the cathodes of Examples 1 and 2 and Comparative Example 1 were each measured, and results obtained by calculating an intensity ratio of a D band peak measured at about 1353 cm⁻¹ (I_{D}) to a G band peak measured at about 1583 cm⁻¹ (I_{G}) are shown in Table 1 and FIGS. 3A and 3B. FIG. 3A shows a Raman spectrum for Examples 1 and 2 and Comparative Example 1, and FIG. 3B is an enlarged view of the left side of the graph i FIG. 3A. In addition, a Raman spectrum of the cathode of Example 5 was measured, and results obtained by calculating an intensity ratio of a D band peak measured at about 1353 cm⁻¹ (I_{D}) to a G band peak measured at about 1583 cm⁻¹ (I_{G}) are shown in Table 1.

TABLE 1

| | Intensity ratio of |
|---|---|
| | peaks (I_{D}/I_{G}) |
| Example 1 | 0.96 |
| Example 2 | 0.89 |
| Example 5 | 0.86 |
| Comparative | 1.07 |
| Example 1 | |

As shown in Table 1 and FIGS. 3A and 3B, the carbon composites of Examples 1, 2, and 5, each of which included semiconductive ZnO coated on a surface of the CNT, had a reduced peak intensity of a D band (I_{D}) which is derived from a defective or disordered carbon (diamond) structure, but an increased peak intensity of a G band which is derived from a graphite structure.

That is, a disordered structure was less likely to be formed on the surface of the carbon composite of each of Examples 1, 2, and 5 while a graphitized crystalline carbon structure was more likely to be formed to thereby increase crystallinity. In this regard, it is considered that the defect of the CNT may be repaired by coating non-insulating ZnO on a defective portion of the surface of the CNT.

In addition, regarding the cathode of Example 2 including ZnO having a greater coating thickness than that of ZnO of Example 1, the cathode of Example 2 had a significantly reduced peak intensity as compared with the cathode of Example 1. Accordingly, it was confirmed that the cathode of Example 2 exhibited significantly improved crystallinity. In addition, regarding the cathode of Example 5 having an increased degree of crystallinity due to the heat treatment, it was confirmed that the cathode of Example 5 exhibited a significantly reduced peak intensity as compared with the cathodes of Examples 1 and 2.

### Evaluation Example 2: Evaluation of Charge/Discharge Characteristics and Free-Standing CNT Film Cathode

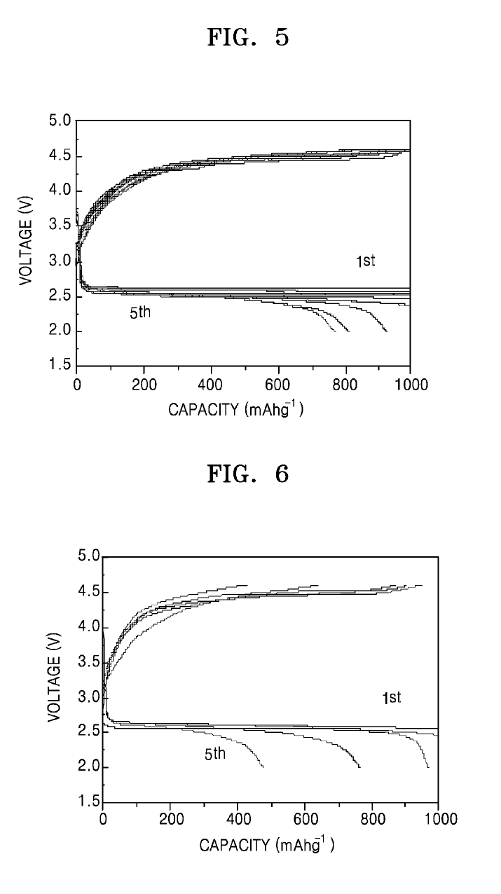

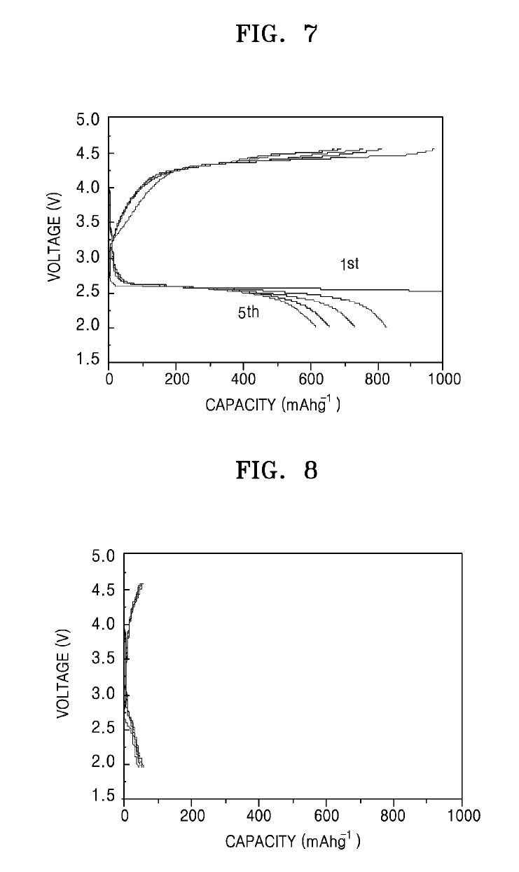

The lithium air batteries of Examples 9, 14, and 15 and Comparative Examples 4 and 6 were each discharged at a constant current of 200 mA per gram of carbon (MA/g_{carbon}) at a temperature of 25° C. and a pressure of 1 atm until a voltage reached 2.0 V (vs. Li) or 1,000 mAh/g_{carbon,} and charged at the same current until the voltage reached 4.6 V. Then, a number of such charging and discharging cycles performed until at least a discharge capacity of 600 mAh/g_{carbon} was maintained at a voltage of 2.0 V (vs. Li) during discharging of the batteries was counted. Some of the results of the charging and discharging tests are shown in Table 2 and FIGS. 4 to 8. FIGS. 4 to 8 are graphs of voltage versus capacity for Example 14, Example 15, Comparative Example 4, and Comparative Example 6, respectively.

TABLE 2

| | Number of cycles where a discharge |
|---|---|
| | capacity of at least 600 mAh/g_{carbon} was |
| | maintained at 2.0 V (vs. Li) [unit: times] |
| Example 9 | 10 |
| Example 14 | 4 |
| Example 15 | 5 |
| Comparative | 3 |
| Example 4 | |
| Comparative | 0 |
| Example 6 | |

As shown in Table 2 and FIGS. 4 to 8, the lithium air batteries of Examples 9, 14, and 15 each including the cathode including carbon composite with the non-insulating coating layer on the carbon core exhibited improved lifespan characteristics as compared with those of the lithium air battery of Comparative Example 4 including the cathode including the carbon core only, and as compared with the lithium air battery of Comparative Example 6 including the cathode including the carbon composite with the insulating coating layer.

### Evaluation Example 3: Evaluation of Charge/Discharge Characteristics and ¹³C Cathode

The lithium air batteries of Examples 12 and 16 and Comparative Example 5 were each discharged at a constant current of 130 mA/g_{carbon} at a temperature of 25° C. and a pressure of 1 atm until a voltage reached 2.0 V (vs. Li) or 0.5 mAh, and then charged at the same current until the voltage reached 4.6 V. Then, a number of such charging and discharging cycles performed until at least a discharge capacity of 0.3 mAh was maintained at the voltage 2.0 V (vs. Li) during discharging of the batteries was counted.

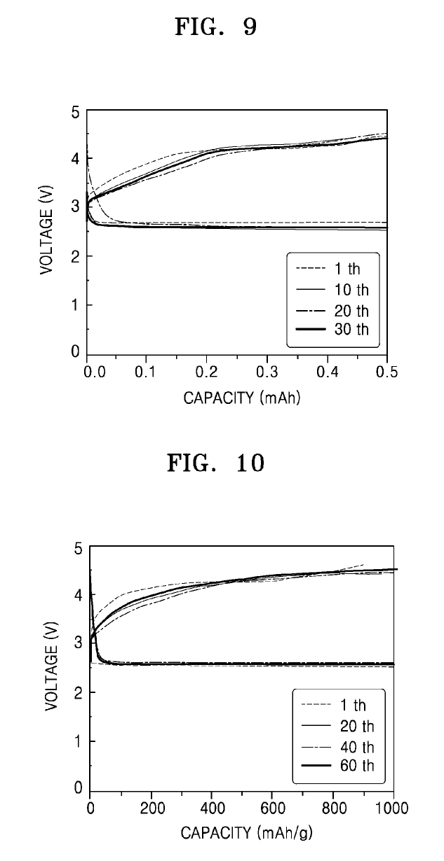

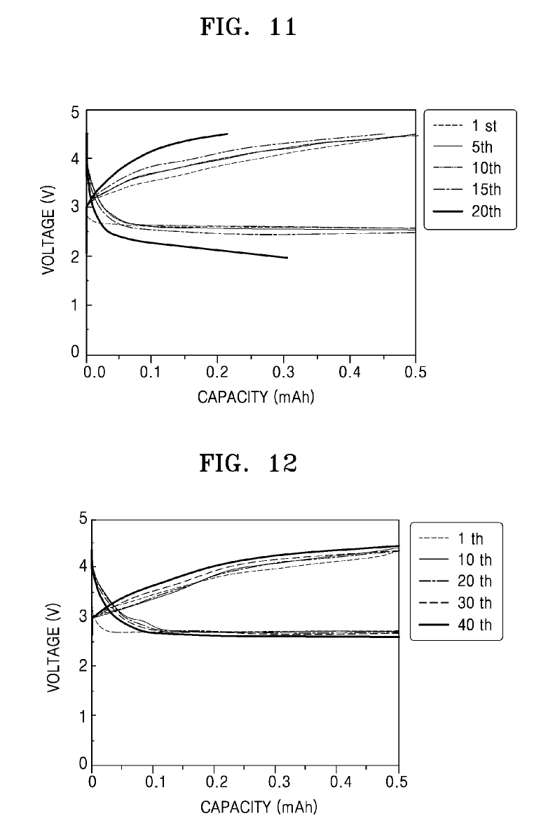

The lithium air battery of Example 13 was discharged at a constant current of 200 mA/g at a temperature of 25° C. and a pressure of 1 atm until a voltage reached 2.0 V (vs. Li) or 1,000 mAh/g_{carbon,} and charged at the same current until the voltage reached 4.6 V. Then, a number of such charging and discharging cycles performed until a discharge capacity of at least 800 mAh/g_{carbon} was maintained at a voltage of 2.0 V (vs. Li) during discharging of the battery was counted. Some of the results of the charging and discharging tests are shown in Table 3 and FIGS. 9 to 12. FIGS. 9 to 12 are graphs of voltage versus capacity for Example 12, Example 13, Comparative Example 5, and Example 16, respectively

TABLE 3

| | Number of cycles where a discharge capacity |
|---|---|
| | of at least 800 mAh/g or 0.3 mAh was |
| | maintained at 2.0 V (vs. Li) [unit: times] |
| Example 12 | 31 |
| Example 13 | 71 |
| Example 16 | 51 |
| Comparative | 20 |
| Example 5 | |

As shown in Table 2 and FIGS. 9 to 12, the lithium air batteries of Examples 12 and 13 each including the cathode including carbon composite with the non-insulating coating layer on the carbon core exhibited significantly improved lifespan characteristics as compared with those of the lithium air battery of Comparative Example 5 including the cathode including the carbon core only. In addition, the lithium air battery of Example 13 including the cathode having improved crystallinity of carbon composite by heat treatment and having a reduced defect exhibited in increase in lifespan characteristics of more than three times.

### Evaluation Example 4: Measurement of Carbon Dioxide Generation

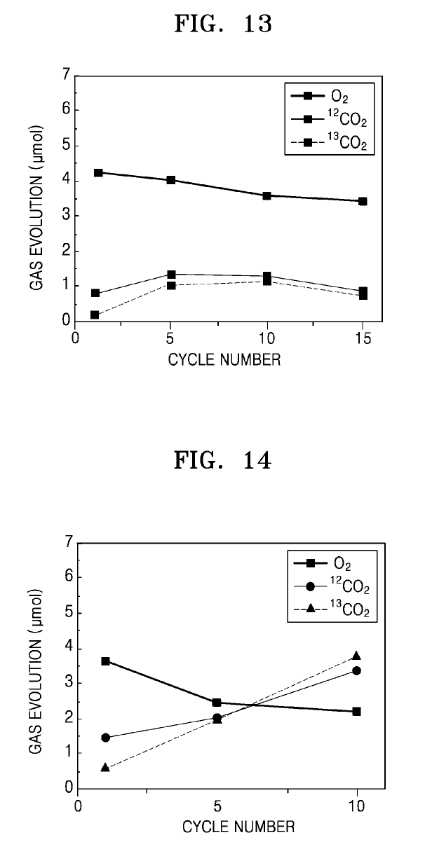

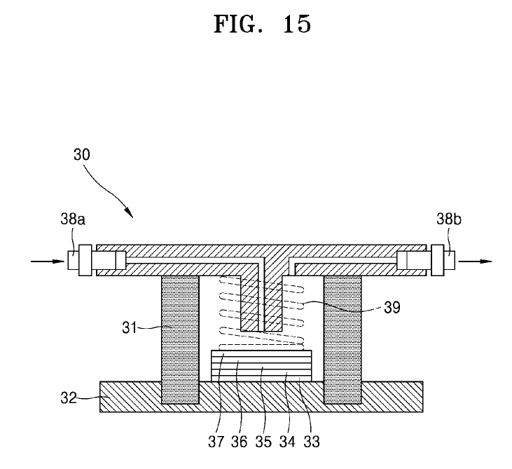

The lithium air batteries of Example 12 and Comparative Example 5 were each discharged at a constant current of 200 mA/g at a temperature of 25□ and a pressure of 1 atm until a voltage reached 2.0 V (vs. Li), and charged at the same current until the voltage reached 4.6 V. Then, an amount of carbon dioxide generated during such charging and discharging cycles was measured by using a differential electrochemical mass spectrometer (DEMS), and the results are shown in FIGS. 13 and 14. FIGS. 13 and 14 are graphs of gas evolution versus cycle number for Example 12 and Comparative Example 5, respectively.

As shown in FIG. 13, the amount of carbon dioxide generated from the lithium air battery of Example 12 increased at the beginning of the charging and discharging cycles of the battery, and decreased after the 5^{th} charging and discharging cycle of the battery. Regarding a decrease in the amount of carbon dioxide generated after the 5^{th} charging and discharging cycle of the battery, without being limited by theory, it is believed that deterioration of the surface of the carbon composite was suppressed by the coating of ZnO on the surface of the carbon composite such that a side reaction in which carbon is separated from the surface of the carbon composite was also reduced.

However, as shown in FIG. 14, as the number of cycles increased in the lithium air battery of Comparative Example 5, the amount of carbon dioxide generated therein also constantly increased. Regarding a constant increase in the amount of carbon dioxide generated, without being limited by theory, it is believed that continuous deterioration of the carbon surface also caused an increase in side reactions in which carbon is separated from the carbon surface.

It was confirmed that, due to use of ¹³C as the carbon core, emission of ¹³CO₂ was caused by deterioration of the carbon core.

As described above, according to the one or more of the above embodiments, use of a lithium air battery including a cathode having a novel structure may improve lifespan characteristics of the lithium air battery.

It should be understood that embodiments described herein should be considered in a descriptive sense only and not for purposes of limitation. Descriptions of features or aspects within each embodiment should be considered as available for other similar features or aspects in other embodiments.

While an embodiment has been described with reference to the figures, it will be understood by those of ordinary skill in the art that various changes in form and details may be made therein without departing from the spirit and scope as defined by the following claims.

What is claimed is:

1. An air battery cathode comprising:
a carbon composite comprising
a core, and
a conductive coating layer disposed on the core,
wherein the core comprises
a first carbon material, a second carbon material, or a combination thereof,
wherein the conductive coating layer comprises a metal-containing semiconductor.

2. The cathode of claim 1, wherein the metal-containing semiconductor comprises a metal belonging to Group 2 to Group 16 of the Periodic Table of the Elements.

3. The cathode of claim 1, wherein the metal-containing semiconductor comprises: a semiconductor comprising an element belonging to Group 14, a semiconductor comprising an element belonging to Group 15, a semiconductor comprising an element belonging to Group 16, a semiconductor comprising elements belonging to Groups 13 and 15, a semiconductor comprising elements belonging to Groups 12 and 16, a semiconductor comprising elements belonging to Groups 11 and 17, a semiconductor comprising elements belonging to Groups 14 and 16, a semiconductor comprising elements belonging to Groups 15 and 16, a semiconductor comprising elements belonging to Groups 12 and 15, and a semiconductor comprising elements belonging to Groups 11, 12, and 16.

4. The cathode of claim 1, wherein the metal-containing semiconductor comprises an oxide of a metal of Groups 2 to 16, a sulfide of metal of Groups 2 to 16, a nitride of metal of Groups 2 to 16, a nitrogen oxide of a metal of Groups 2 to 16, a phosphide of a metal of Groups 2 to 16, an arsenide of metal of Groups 2 to 16, or a combination thereof.

5. The cathode of claim 1, wherein the metal-containing semiconductor comprises ZnₐO_{b} wherein 0<a≦2 and 0<b≦2, SnₐO_{b} wherein 0<a≦2 and 0<b≦2, SrₐTi_{b}O_{c} wherein 0<a≦2, 0<b≦2, and 0<c≦2, TiₐO_{b} wherein 0<a≦2 and 2<b≦4, BaₐTi_{b}O_{c} wherein 0<a≦2, 0<b≦2, and 2<c≦4, CuₐO_{b} wherein 1<a≦3 and 0<b≦2, CuₐO_{b} wherein 0<a≦2 and 0<b≦2, BiₐO_{b} wherein 1≦a≦3 and 2≦b≦4, FeₐS_{b} wherein 0<a≦2 and 1≦b≦3, SnₐS_{b} wherein 0<a≦2 and 0<b≦2, BiₐS_{b} wherein 1≦a≦3 and 2≦b≦4, BiₐSe_{b} wherein 1≦a≦3 and 2≦b≦4, BiₐTe_{b} wherein 1≦a≦3 and 2≦b≦4, SnₐS_{b} wherein 0<a2 and 1g)3, PbₐS_{b} wherein 0<a≦2 and 0<b≦2, ZnₐS_{b} wherein 0<a≦2 and 0<b≦2, MoₐS_{b} wherein 0<a≦2 and 1≦b≦3, PbₐTe_{b} wherein 0<a≦2 and 0<b≦2, SnₐTe_{b} wherein 0<a≦2 and 0<b≦2, GaₐN_{b} wherein 0<a≦2 and 0<b≦2, GaₐP_{b} wherein 0<a≦2 and 0<b≦2, BₐP_{b} wherein 0<a≦2 and 0<b≦2, BaₐS_{b} wherein 0<a≦2 and 0<b≦2, GaₐAs_{b} wherein 0<a≦2 and 0<b≦2, ZnₐSe_{b} wherein 0<a≦2 and 0<b≦2, ZnₐTe_{b} wherein 0<a≦2 and 0<b≦2, CdₐTe_{b} wherein 0<a≦2 and 0<b≦2, CdₐSe_{b} wherein 0<a≦2 and 0<b≦2, or a combination thereof.

6. The cathode of claim 1, wherein the metal-containing semiconductor comprises ZnO, SnO, SrTiO, BaTiO₃, TiO₂, Cu₂O, CuO, Bi₂O₃, FeS₂, SnS, Bi₂S₃, Bi₂Se₃, Bi₂Te₃, SnS₂, PbS, ZnS, MoS₂, PbTe, SnTe, GaN, GaP, BP, BaS, GaAs, ZnSe, ZnTe, CdTe, CdSe, or a combination thereof.

7. The cathode of claim 1, wherein the metal-containing semiconductor has a bandgap energy of 5.0 electron volts or less.

8. The cathode of claim 1, wherein the metal-containing semiconductor has a resistivity of 1×10⁷ ohm centimeters or less at a temperature of 20° C.

9. The cathode of claim 1, wherein the conductive coating layer has a thickness of 20 nanometers or less.

10. The cathode of claim 1, wherein the conductive coating layer is a discontinuous layer disposed on a surface of the core.

11. The cathode of claim 1, wherein the conductive coating layer is disposed on the core in a form of islands of the conductive coating on a surface of the core.

12. The cathode of claim 1, wherein the core is in a form of a sphere, a rod, a plate, a tube, or a combination thereof.

13. The cathode of claim 1, wherein the first carbon material comprises carbon black, Ketjen black, acetylene black, natural graphite, artificial graphite, expanded graphite, graphene, graphene oxide, fullerene soot, mesocarbon microbead, carbon nanotube, carbon nanofiber, carbon nanobelt, soft carbon, hard carbon, pitch carbon, mesophase pitch carbide, sintered coke, or a combination thereof.

14. The cathode of claim 1, wherein the first carbon material comprises crystalline carbon.

15. The cathode of claim 1, wherein in a Raman spectrum, a ratio of a D-band intensity to a G band intensity of the carbon composite is 1 or less.

16. The cathode of claim 1, wherein the carbon composite does not comprise a catalyst for oxidation or reduction of oxygen, wherein the catalyst comprises a metal particle, a metal oxide nanoparticle, or a combination thereof.

17. The cathode of claim 1, wherein the second carbon material is a product of heat treatment of the first carbon material.

18. The cathode of claim 17, wherein the heat treatment is performed at a temperature in a range from about 700° C. to about 2,500° C.

19. The cathode of claim 1, wherein in the carbon composite, a specific surface area of the second carbon material is about 90% or less of a specific surface area of the first carbon material.

20. The cathode of claim 1, wherein, in a Raman spectrum, a ratio of a D-band intensity to a G-band intensity of the second carbon material is about 90% or less of a ratio of D-band intensity to a G-band intensity of the first carbon material.

21. The cathode of claim 1, wherein an amount of the metal-containing semiconductor is in a range of about 1 part to about 300 parts by weight, based on 100 parts by weight of the core.

22. A lithium air battery, comprising,
a cathode;
an anode; and
an electrolyte layer disposed between the cathode and the anode, wherein the cathode comprises:
a carbon composite comprising a core, and a conductive coating layer disposed on the core,
wherein the core comprises a first carbon material and a second carbon material, and
wherein the conductive coating layer comprises a metal-containing semiconductor.

23. The lithium air battery of claim 22, wherein a number of cycles at which a discharge capacity of the air battery is maintained at about 80% or more of a discharge capacity of a first cycle is greater than 20, when measured by charging and discharging the air battery to a cut-off voltage of 2 volts versus lithium.

24. The lithium air battery of claim 23, wherein an amount of carbon dioxide generated at a 15^{th} cycle of charging and discharging is less than an amount of carbon dioxide generated at a 10^{th} cycle.

25. A method of preparing a cathode, the method comprising:
providing a first carbon material; and
preparing a carbon composite by disposing a conductive coating layer on the first carbon material, the coating layer comprising a metal-containing semiconductor, to prepare the cathode.

26. The method of claim 25, wherein the disposing of the conductive coating layer comprises a deposition method.

27. The method of claim 26, wherein the deposition method comprises atomic layer deposition, physical vapor deposition, or chemical vapor deposition.

28. The method of claim 25, further comprising heat treating the carbon composite at a temperature in a range from about 700° C. to about 2,500° C.
